(19) United States
(12) Patent Application Publication
(10) Pub. No.: US 2024/0222983 A1
(43) Pub. Date: Jul. 4, 2024

(54) LITHIUM BATTERY SUPPORTING SERIES-PARALLEL

(71) Applicant: ARI ENERGY (HUIZHOU) CO.,LTD, Huizhou (CN)

(72) Inventor: Yingqiang ZHENG, Huizhou (CN)

(73) Assignee: ARI ENERGY (HUIZHOU) CO.,LTD, Huizhou (CN)

(21) Appl. No.: 18/512,669

(22) Filed: Nov. 17, 2023

(30) Foreign Application Priority Data
Dec. 29, 2022 (CN) 202211742355.9

(51) Int. Cl. H02J 7/00; H01M 10/44

(52) U.S. Cl. CPC H02J 7/0013; H01M 10/441; H02J 7/00041; H02J 7/0063; H02J 7/0068; H01M 2010/4271

(57) ABSTRACT

Disclosed is a lithium battery supporting series-parallel. The lithium battery includes: a battery cell assembly, a carrier communication assembly, a wake-up detection assembly, a charge-discharge control detection assembly, a battery management assembly and a battery output on/off execution assembly. The present application assigns a high-voltage group attribute to the battery at the highest voltage in series in a series-parallel battery system, and assigns a low-voltage group attribute to all batteries at other voltages other than the highest voltage in series. The battery management assembly controls the output on/off execution assembly of the battery based on its attribute, making it in different on, current-limiting on or off states. The battery management assembly controls the wake-up detection assembly to detect various wake-up signals according to the battery attributes, so as to realize the use of multiple lithium batteries in any series and parallel connection.

### CROSS-REFERENCE TO RELATED APPLICATIONS

This application claims priority to Chinese Patent Application No. 202211742355.9, filed on Dec. 29, 2022, the entire contents of which are incorporated herein by reference.

### TECHNICAL FIELD

The present application relates to the technical field of lithium batteries, and in particular to a lithium battery supporting series-parallel.

### BACKGROUND

Current lithium batteries can only be used alone during use, and multiple lithium batteries are not allowed to be directly connected in series and parallel through wires to build battery packs with different voltages and capacities. When users need lithium batteries with different voltages and capacities, they can only choose a single lithium battery with similar voltage and capacity, or customize a single lithium battery that fully meets their requirements. As the number of charge-discharge cycles of lithium batteries increases, the performance of some battery cell of the battery will decline. This issue gradually becomes a shortcoming of the battery, which limits the battery's charge-discharge capabilities. When the performance of the battery deteriorates to a certain extent, users must perform an overall replacement of the battery, thereby reducing the usage efficiency of lithium battery and increasing its overall cost.

### SUMMARY

The main purpose of the present application is to provide a lithium battery supporting series-parallel, which aims to simply connect multiple lithium batteries in series and parallel through wires to build battery systems with different voltages and capacities, thereby improving the usage efficiency of lithium batteries.

In order to achieve the above purpose, the present application proposes a lithium battery supporting series-parallel, including:
a battery cell assembly, configured to store electric energy;
a carrier communication assembly, configured to establish communication among a plurality of lithium batteries supporting series-parallel;
a wake-up detection assembly, configured to provide a wake-up signal for batteries which do not use a charge-discharge control detection assembly in a series-parallel battery system, so as to switch the batteries from a shutdown state to a working state;
the charge-discharge control detection assembly, configured to detect on/off status of a discharge switch and an auxiliary power supply of a charger, so as to provide a booting signal and a shutdown signal for a battery management assembly;
the battery management assembly, configured to manage wake-up, startup, charging-discharging and communication of the batteries in response to receiving the booting signal, and manage shutdown of the batteries in response to receiving the shutdown signal; and
a battery output on/off execution assembly, configured to control on and off of a battery charge-discharge circuit and a current limiting charge-discharge circuit, receive control of the battery management assembly, provide feedback to the battery management assembly, and provide the wake-up signal for the wake-up detection assembly.

The battery management assembly is electrically connected to the battery cell assembly, the carrier communication assembly, the wake-up detection assembly, the charge-discharge control detection assembly, and the battery output on/off execution assembly respectively.

In an embodiment, the battery output on/off execution assembly includes a contactor, a relay, a metal-oxide-semiconductor (MOS) transistor and a current-limiting resistor.

A first end of the contactor is connected to the battery cell assembly, and a second end of the contactor is connected to a second end of the current limiting resistor; and a connecting point between the first end of the contactor and the battery cell assembly is connected to a first end of the relay, a first end of the current limiting resistor is connected to a second end of the MOS transistor, and a first end of the MOS transistor is connected to a second end of the relay.

In an embodiment, in response to constructing a battery system, a plurality of the batteries are connected in series-parallel, the batteries with highest voltage in the battery system are high-voltage batteries, and the batteries except for the high-voltage batteries are low-voltage batteries.

In an embodiment, the battery management assembly in the low-voltage batteries is configured to control the contactor to disconnect, the relay to conduct and the MOS transistor to turn on during system shutdown and wake-up processes, so as to conduct current-limiting paths between the low-voltage batteries and other batteries, and control the contactor to connect, the relay to disconnect and the MOS transistor to turn off after the system is started up.

In an embodiment, the charge-discharge control detection assembly is configured to output the booting signal after detecting the turn on of a discharge switch or the auxiliary power supply of the charger, and output the shutdown signal after detecting the turn off of the discharge switch or the auxiliary power supply of the charger.

The battery management assembly in the high-voltage batteries is configured to control the relay to conduct and the MOS transistor to turn on in response to receiving the booting signal, so as to conduct current-limiting paths between the high-voltage batteries and other batteries, and control the contactor and the relay to disconnect and the MOS transistor to turn off in response to receiving the shutdown signal, so as to completely disconnect charging-discharging paths between the series-parallel battery system and an external load.

In an embodiment, the carrier communication assembly includes a carrier generator, a coupling transformer, a blocking capacitor and a fuse.

The carrier generator is respectively connected to the battery management assembly and the coupling transformer.

The coupling transformer is respectively connected to a second end of the blocking capacitor and a first end of the fuse, a first end of the blocking capacitor is connected to a positive electrode of the battery, and a second end of the fuse is connected to a negative electrode of the battery.

The carrier generator is configured to demodulate a carrier signal into a digital signal and output the digital signal to the battery management assembly in response to receiving the carrier signal, and modulate the digital signal into the carrier signal and output the carrier signal to the coupling transformer in response to detecting the digital signal sent by the battery management assembly.

The coupling transformer is configured to couple the carrier signal.

The blocking capacitor is configured to isolate a direct-current voltage of the batteries.

The fuse is configured to protect the battery cell assembly from a short circuit caused by isolation failure of the blocking capacitor.

In an embodiment, the wake-up detection assembly includes:
a parallel wake-up detection assembly, configured to wake up high-voltage batteries;
a discharge wake-up detection assembly, configured to wake up low-voltage batteries.

In an embodiment, the lithium battery supporting series-parallel further includes a function button connected to the battery management assembly, and the function button is configured to trigger the battery management assembly to control a display assembly to work.

In an embodiment, the lithium battery supporting series-parallel further includes:
a display assembly, connected to the battery management assembly;
wherein the battery management assembly is also configured to control the display assembly to work in response to being triggered.

The present application assigns a high-voltage group attribute to the battery at the highest voltage in series in a series-parallel battery system, and assigns a low-voltage group attribute to all batteries at other voltages other than the highest voltage in series. The battery management assembly controls the output on/off execution assembly of the battery based on its attribute, allowing it to be in different on or current-limiting on or off states. Furthermore, the battery management assembly controls the wake-up detection assembly to detect various wake-up signals according to the battery attributes, so as to realize the use of multiple lithium batteries in any series and parallel connection, and to achieve data exchange among batteries in the series-parallel battery system through the carrier communication assembly.

### BRIEF DESCRIPTION OF THE DRAWINGS

In order to more clearly illustrate the technical solution in the embodiments of the present application or in the related art, the accompanying drawings used in the embodiments or the related art will be briefly described below. Obviously, the accompanying drawings in the following description are only some embodiments of the present application. For those skilled in the art, other drawings can be obtained according to the structures shown in these drawings without creative efforts.

FIG. 1 is a schematic circuit structural diagram of a lithium battery supporting series-parallel according to the present application.

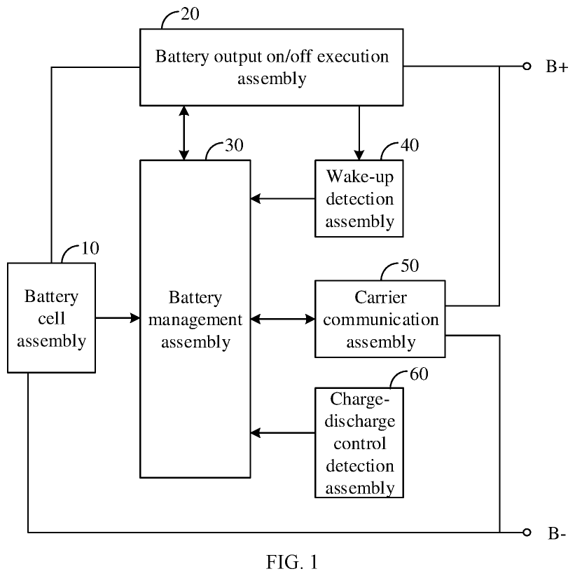

FIG. 2 is a schematic circuit structural diagram of a lithium battery supporting series-parallel according to another embodiment of the present application.

FIG. 3 is a schematic circuit structural diagram of a lithium battery supporting series-parallel according to another embodiment of the present application.

FIG. 4 is a schematic circuit structural diagram of a lithium battery supporting series-parallel according to another embodiment of the present application.

FIG. 5 is a schematic circuit structural diagram of a lithium battery supporting series-parallel according to another embodiment of the present application.

The realization of the purpose, functional characteristics, and advantages of the present application will be further described in conjunction with the embodiments and with reference to the accompanying drawings.

### DETAILED DESCRIPTION OF THE EMBODIMENTS

The technical solutions in the embodiments of the present application will be described clearly and completely below with reference to the accompanying drawings in the embodiments of the present application. It is obvious that the described embodiments are only some rather than all of the embodiments of the present application. All other embodiments obtained by those skilled in the art based on the embodiments of the present application without creative efforts shall fall within the scope of the present application.

It should be noted that if there is a directional indication (such as up, down, left, right, front, rear . . . ) in the embodiments of the present application, the directional indication is only used to explain the relative positional relationship, movement, etc. of the components in a certain posture (as shown in the drawings). If the specific posture changes, the directional indication will change accordingly.

It should be noted that, it there are descriptions such as “first” and “second” in the embodiments of the present application, the descriptions such as “first” and “second” are merely for descriptive purposes, and cannot be understood as indicating or implying relative importance or implicitly indicating the number of the indicated technical features. Therefore, the feature defined with “first” or “second” can explicitly or implicitly include at least one such feature. In addition, the meaning of “and/or” in the entire text is to include three parallel solutions, taking “A and/or B” as an example, including A solution, or B solution, or solutions that both A and B meet. In addition, the technical solutions between the various embodiments can be combined with each other, but the combination must be based on the realization of those skilled in the art. When the combination of technical solutions is contradictory or cannot be achieved, it should be considered that such combination of technical solutions does not exist, and is not within the scope of the present application.

It should be understood, current lithium batteries can only be used alone during use, and multiple lithium batteries are not allowed to be directly connected in series and parallel through wires to build battery packs with different voltages and capacities. When users need lithium batteries with different voltages and capacities, they can only choose a single lithium battery with similar voltage and capacity, or customize a single lithium battery that fully meets their requirements. As the number of charge-discharge cycles of lithium batteries increases, the performance of some battery cell of the battery will decline. This issue gradually becomes a shortcoming of the battery, which limits the battery's charge-discharge capabilities. When the performance of the battery deteriorates to a certain extent, users must perform an overall replacement of the battery, thereby reducing the usage efficiency of lithium battery and increasing its overall cost.

Therefore, the present application proposes a lithium battery supporting series-parallel, including: a battery cell assembly 10, a battery output on/off execution assembly 20, a battery management assembly 30, a wake-up detection assembly 40, a carrier communication assembly 50 and a charge-discharge control detection assembly 60.

The battery management assembly 30 is electrically connected to the battery cell assembly 10, the battery output on/off execution assembly 20, the wake-up detection assembly 40, the carrier communication assembly 50, and the charge-discharge control detection assembly 60, respectively.

The battery cell assembly 10 is configured to store electric energy.

The carrier communication assembly 50 is configured to establish communication among a plurality of lithium batteries supporting series-parallel.

The wake-up detection assembly 40 is configured to provide a wake-up signal for batteries which do not use the charge-discharge control detection assembly 60 in a series-parallel battery system, so as to switch the batteries from a shutdown state to a working state.

The charge-discharge control detection assembly 60 is configured to detect on/off status of a discharge switch and an auxiliary power supply of a charger, so as to provide a booting signal and a shutdown signal for the battery management assembly 30.

The battery management assembly 30 is configured to manage wake-up, startup, charging-discharging and communication of the batteries in response to receiving the booting signal, and manage shutdown of the batteries in response to receiving the shutdown signal.

The battery output on/off execution assembly 20 is configured to control on and off of a battery charge-discharge circuit and a current limiting charge-discharge circuit, receive control of the battery management assembly 30, provide feedback to the battery management assembly 30, and provide the wake-up signal for the wake-up detection assembly 40.

In an embodiment, in a battery system constructed from a plurality of lithium batteries that support series-parallel, the voltage and capacity of the system can be achieved through different numbers of series and parallel connections as needed. The diversification of system voltages and capacities can solve the customization problem of battery systems with different voltages and capacities required for vehicles, ships and other equipment. Users can replace a battery with degraded performance without affecting the operation of other batteries when the performance of that battery degrades. However, the voltages and capacities of multiple batteries used to build a battery system cannot be exactly the same. Batteries connected in parallel are on the same voltage reference, while batteries connected in series are on different voltage references. In order to enable a plurality of batteries connected in series-parallel to work together under conditions where the voltage and capacity are not exactly the same, the balance between the batteries needs to be considered.

Therefore, in this embodiment, the properties of batteries are divided into two types, namely high-voltage batteries and low-voltage batteries. High-voltage batteries are connected in parallel with each other, low-voltage batteries with the same voltage reference are connected in parallel with each other, and high-voltage batteries and low-voltage batteries with different voltage references are connected in series with each other. The battery with highest voltage among the batteries connected in series with each other is the high-voltage battery, and batteries other than the high-voltage battery among the batteries connected in series with each other are all low-voltage batteries. It should be understood that, the cycle lifetime of the batteries can last longer if the batteries maintain continuous equalization. In this embodiment, no matter the battery system is in a non-working state or a working state, the battery output on/off execution assembly 20 inside the low-voltage battery is in a conductive state, and low-voltage batteries with the same voltage reference can be continuously balanced. On the contrary, to prevent electric leakage caused by continuous external discharge of the battery system in the non-working state, when the battery system is in the non-working state, the battery output on/off execution assembly 20 inside the high-voltage battery is in a disconnected state, and the high-voltage batteries in the high-voltage battery pack are not balanced.

In an embodiment, a lithium battery system supporting series-parallel includes a plurality of high-voltage batteries and a plurality of low-voltage batteries. Multiple high-voltage batteries are connected in parallel with each other, and each high-voltage battery includes a battery cell assembly 10, a battery output on/off execution assembly 20, a battery management assembly 30, a wake-up detection assembly 40, a carrier communication assembly 50 and a charge-discharge control detection assembly 60. In practical application, the charge-discharge control detection assembly 60 outputs a booting signal to the battery management assembly 30, in response to detecting the discharge switch and the auxiliary power supply of charger being turned on. The battery management assembly 30 receives the booting signal, then controls the high-voltage battery to be turned on and the battery output on/off execution assembly 20 to connect the battery current limiting charge-discharge circuit. At this time, the cell voltage of the high-voltage battery can be output to other high-voltage batteries connected in parallel through the battery charge-discharge circuit, so that the multiple high-voltage batteries connected in parallel with each other can be balanced and the voltage can be output to the outside.

In an embodiment, when the charge-discharge control detection assembly 60 detects that the discharge switch and the auxiliary power supply of the charger is turned off, it outputs a shutdown signal to the battery management assembly 30. The battery management assembly 30 receives the shutdown signal and controls the high-voltage battery to shut down, so that the high-voltage battery stops discharging or charging. Meanwhile, the battery output on/off execution assembly 20 and the wake-up detection assembly 40 are controlled to turn off, the battery output on/off execution assembly 20 controls both the battery charge-discharge circuit and a current limiting charge-discharge circuit to be disconnected, so that the charging-discharging paths of the series-parallel battery system to the external load are completely disconnected. At this time, the cell voltage output by the high-voltage battery cannot be output to other high-voltage batteries connected in parallel through the battery charge-discharge circuit, and the multiple high-voltage battery cell assembly 10 connected in parallel stops balancing and the voltage cannot be output to the outside.

In some embodiments, a plurality of low-voltage batteries are connected in parallel, and a plurality of high-voltage batteries connected in parallel are connected in series with a plurality of low-voltage batteries connected in parallel. Every low-voltage battery includes a battery cell assembly 10, a battery output on/off execution assembly 20, a battery management assembly 30, a wake-up detection assembly 40, a carrier communication assembly 50 and a charge-discharge control detection assembly 60. In practical application, when the charge-discharge control detection assembly 60 within a certain high-voltage battery detects that the discharge switch and the auxiliary power supply of the charger are turned on, the battery management assembly 30 receives the booting signal and controls the high-voltage battery to turn on. At the same time, the battery output on/off execution assembly 20 will control the battery charging-discharging circuit to be on, and the low-voltage battery wakes up and starts working by the discharge current generated by the external load. In this way, the voltages of a plurality of low-voltage batteries connected in parallel can be balanced and the voltage can be output to the outside.

It should be understood, the current limiting charge-discharge circuit for the low-voltage batteries remains open at all times, and regardless of whether the battery system is in the working/non-working state, there is always voltage balance between the low-voltage batteries. Furthermore, due to a plurality of low-voltage batteries being connected in series with a plurality of high-voltage batteries, the paths between the high-voltage batteries are disconnected when the battery system is in the non-working state, and cannot be discharged externally. Even if the paths between the low-voltage batteries are always conductive when the battery system is in the non-working state, it will not affect the voltage balance between the low-voltage batteries, nor will it result in the continuous external discharge of the battery system.

The present application proposes a lithium battery supporting series-parallel, including a battery cell assembly 10, a battery output on/off execution assembly 20, a battery management assembly 30, a wake-up detection assembly 40, a carrier communication assembly 50 and a charge-discharge control detection assembly 60. The battery cell assembly 10 is configured to store electric energy, and is connected to both the battery output on/off execution assembly 20 and the battery management assembly 30. The battery output on/off execution assembly 20 is configured for the connection and disconnection of the battery charging-discharging circuit (including current limiting charging and discharging), receives control from the battery management assembly 30, provides feedback on the status to the battery management assembly 30, and provides a wake-up signal to the wake-up detection assembly 40. The battery management assembly 30 is the main controller of the battery and manages the wake-up, power on/off, charging-discharging, and communication of the battery. The wake-up detection assembly 40 provides a wake-up signal to batteries that do not use the charge-discharge control detection assembly 60 in the series-parallel battery system, so that the batteries switch from the shutdown state to the working state. The carrier communication assembly 50 is configured for data exchange between batteries. The charge-discharge control detection assembly 60 detects the on/off status of the discharge switch and an auxiliary power supply of a charger, and provides the battery management assembly 30 with booting signal or shutdown signal.

The present application assigns a high-voltage group attribute to the battery at the highest voltage in series in a series-parallel battery system, and assigns a low-voltage group attribute to all batteries at other voltages other than the highest voltage in series. The battery management assembly 30 controls the output on/off execution assembly of the battery based on its attribute, allowing it to be in different on or current-limiting on or off states. Furthermore, the battery management assembly 30 controls the wake-up detection assembly 40 to detect various wake-up signals according to the battery attributes, so as to realize the use of multiple lithium batteries in any series and parallel connection, and to achieve data exchange among batteries in the series-parallel battery system through the carrier communication assembly 50.

In addition, it can be understood that, in a series-parallel battery system constructed by lithium batteries that support series-parallel connection, when a plurality of batteries with different voltages and capacities in the system have faults such as over-temperature, over-voltage, over-current, under-voltage, or low battery capacity, a failure of a single battery will implicate and damage other batteries, and even cause damage to the entire series-parallel battery system, since other batteries do not have a bridge to communicate with each other. Therefore, to establish a reliable series-parallel battery system, this embodiment includes a carrier communication assembly 50 for enabling communication between a plurality of lithium batteries supporting series-parallel. This communication allows for the disconnection of the entire series-parallel battery system when severe battery failures occur, thereby maintaining a safe and reliable working state for lithium batteries that support series-parallel connection.

More specifically, in practical application, when the series-parallel battery system is in the working state, the carrier communication assembly 50 modulates the communication data packets of the battery management assembly 30 into carrier signals and outputs them to other carrier communication assemblies 50. This allows other carrier communication assemblies 50 to output the communication data packets to the battery management assembly 30, and to enable data exchange between the battery management assembly 30 and other battery management assemblies 30. When a severe failure occurs in the battery where the battery management assembly 30 is located, the other battery management assemblies 30 can be informed through carrier signals. The series-parallel battery system can immediately make a shutdown action to stop the entire series-parallel battery system from working, thereby preventing the safety hazards of a plurality of lithium batteries supporting series-parallel.

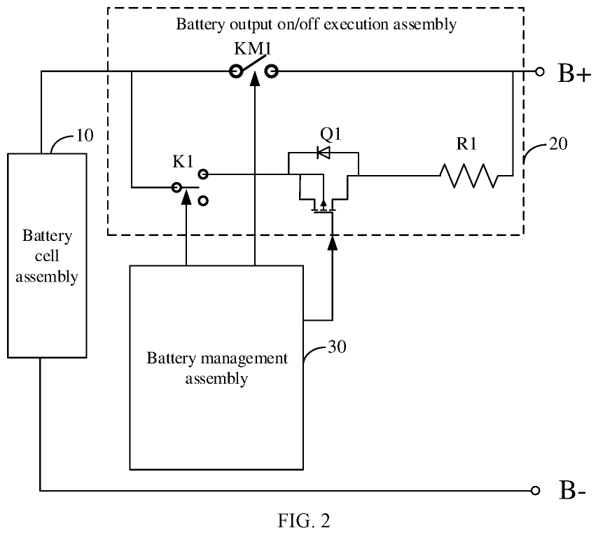

In this embodiment, referring to FIG. 2, the battery output on/off execution assembly 20 includes a contactor KM1, a relay K1, a metal-oxide-semiconductor (MOS) transistor Q1 and a current-limiting resistor R1.

A first end of the contactor KM1 is connected to the battery cell assembly 10, and a second end of the contactor KM1 is connected to a second end of the current-limiting resistor R1; and a connecting point between the first end of the contactor KM1 and the battery cell assembly 10 is connected to a first end of the relay K1, a first end of the current-limiting resistor R1 is connected to a second end of the MOS transistor Q1, and a first end of the MOS transistor Q1 is connected to a second end of the relay K1.

It should be understood that, the battery output on/off execution assembly 20 includes a battery charge-discharge circuit and a current limiting charge-discharge circuit, the battery charge-discharge circuit includes a contactor KM1, and the current limiting charge-discharge circuit includes a relay K1, a MOS transistor Q1 and a current-limiting resistor R1.

In this embodiment, in response to constructing a battery system, a plurality of the batteries are connected in series-parallel, the batteries with highest voltage in the battery system are high-voltage batteries, and the batteries except for the high-voltage batteries are low-voltage batteries.

It should be understood, the biggest difference between a series-parallel battery system and a battery used alone is that the batteries in the series-parallel battery system have a series-parallel relationship with each other, specifically, batteries connected in parallel are on the same voltage reference and batteries connected in series are on different voltage references. In order to enable a plurality of series-parallel batteries to work together, the properties of batteries are divided into two types in the present application, namely high-voltage batteries and low-voltage batteries. The high-voltage battery does not perform voltage balancing when it is turned off, and the low-voltage battery performs voltage balancing whether it is off or on, so as to form a stable series-parallel battery system.

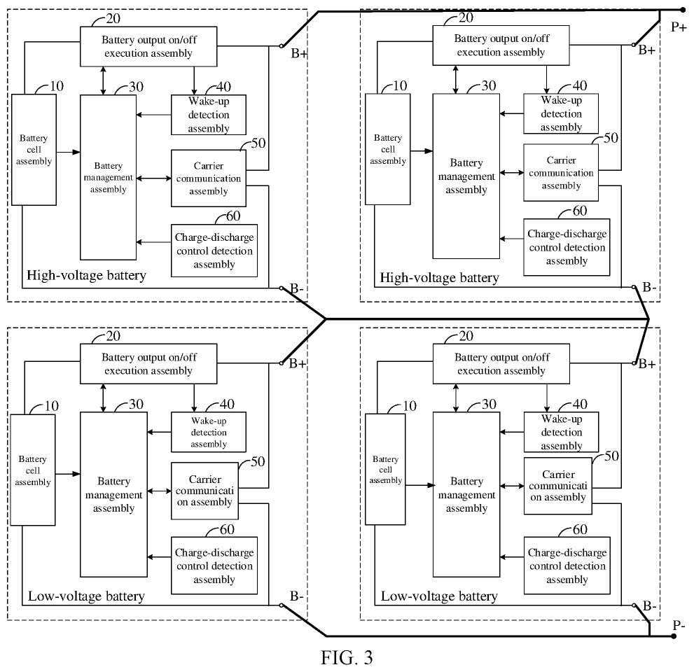

In this embodiment, referring to FIG. 2 and FIG. 3, the battery management assembly 30 in the low-voltage batteries is configured to control the contactor KM1 to disconnect, the relay K1 to conduct and the MOS transistor Q1 to turn on during system shutdown and wake-up processes, so as to conduct current-limiting paths between the low-voltage batteries and other batteries, and control the contactor KM1 to connect, the relay K1 to disconnect and the MOS transistor Q1 to turn off after the system is started up.

In practical application, the battery management assembly 30 in the high-voltage batteries is configured to control the relay K1 to conduct and the MOS transistor Q1 to turn on in response to receiving the booting signal, so as to conduct current-limiting paths between the high-voltage batteries and other batteries, and control the contactor KM1 and the relay K1 to disconnect and the MOS transistor Q1 to turn off in response to receiving the shutdown signal, so as to completely disconnect charging-discharging paths between the series-parallel battery system and an external load.

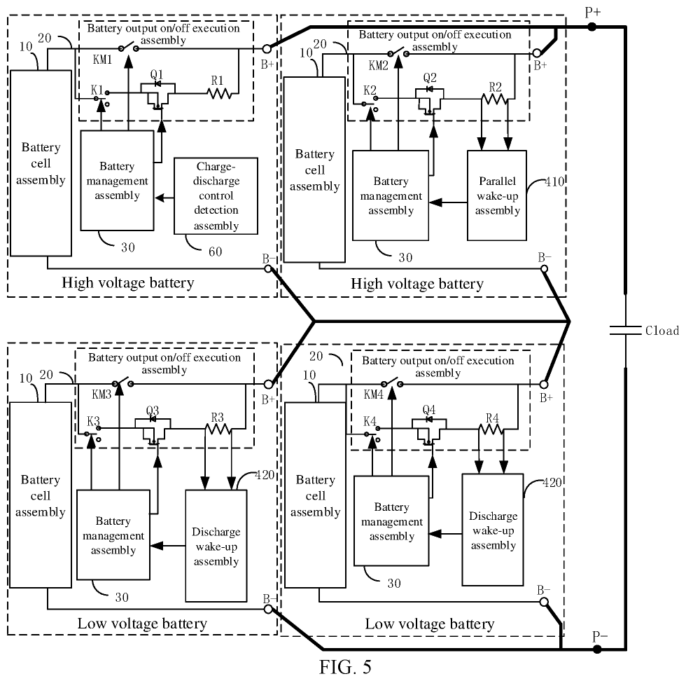

In the embodiment, referring to FIG. 5, the charge-discharge control detection assembly 60 is configured to output the booting signal after detecting the turn on of a discharge switch or the auxiliary power supply of the charger, and output the shutdown signal after detecting the turn off of the discharge switch or the auxiliary power supply of the charger.

The battery management assembly 30 in the high-voltage batteries is configured to control the relay to conduct and the MOS transistor Q1 to turn on in response to receiving the booting signal, so as to conduct current-limiting paths between the high-voltage batteries and other batteries, and control the contactor and the relay to disconnect and the MOS transistor Q1 to turn off in response to receiving the shutdown signal, so as to completely disconnect charging-discharging paths between the series-parallel battery system and an external load.

It should be understood, the cycle lifetime of the batteries can last longer if the batteries maintain continuous equalization. Because the low-voltage battery and the high-voltage battery are connected in series and parallel to each other, the battery system will not discharge externally, even if the low-voltage battery performs voltage balancing when the battery system in the non-working state. Therefore, the low-voltage battery cell assembly 10 in this embodiment can perform voltage balancing when the battery system is in the working state or non-working state.

In an embodiment, referring to FIG. 3 and FIG. 5, a description is given as an example in which that two high-voltage batteries are connected in parallel to each other, two low-voltage batteries are connected in parallel to each other, and two high-voltage batteries are connected in series with two low-voltage batteries.

When the battery system is in the non-working state, the high-voltage battery is turned on by the booting signal output by the charge-discharge control detection assembly 60. The battery management assembly 30 controls the conduction of the relay K1 and the MOS transistor Q1, so as to conduct the current limiting charge-discharge circuit, thereby enabling the battery voltage output by the battery cell assembly 10 in the high-voltage battery to be output to the outside through the current limiting charge-discharge circuit. The parallel wake-up assembly of another high-voltage battery will wake up the high-voltage battery and conduct the current limiting charge-discharge circuit. Furthermore, since the low-voltage battery and the high-voltage battery are connected in series, and the current-limiting charge and discharge circuit inside the low-voltage battery is in a constant conduction state, when the high-voltage battery is turned on, both the low-voltage and high-voltage batteries discharge the external load through the current-limiting charge and discharge circuit. Then the discharge wake-up assembly inside the low-voltage battery will wake up the low-voltage battery, resulting in the entire series-parallel battery system being in working state.

When the battery system is in the non-working state, the high-voltage battery is shut down, and the battery management assembly 30 controls to disconnect the contactor KM1 and the relay K1, and close the MOS transistor Q1, thereby simultaneously disconnecting the battery charge-discharge circuit and the current-limiting charge-discharge circuit. At this time, the path of the battery cell assembly 10 in the high-voltage battery to external output voltage is completely disconnected, so that the charging-discharging path of the series-parallel battery system to the external load is completely disconnected. This process prevents the voltage of the battery system from being consumed due to the continuous output of the high-voltage battery, and avoids the phenomenon of leakage caused by the high-voltage battery still outputting voltage to the outside when the battery system is in the non-working state.

Besides, it should be understood, after detecting that the discharge switch or auxiliary power supply of the charger is turned on, the charge-discharge control detection assembly 60 outputs a booting signal to the battery management assembly 30, causing the battery management assembly 30 to start the work of the battery where it is located, thereby making the battery system in the working state. Or after detecting that the discharge switch or auxiliary power supply of the charger is shut down, the charge-discharge control detection assembly 60 outputs a shutdown signal to the battery management assembly 30, causing the battery management assembly 30 to stop the work of the battery where it is located, thereby making the battery system stop working.

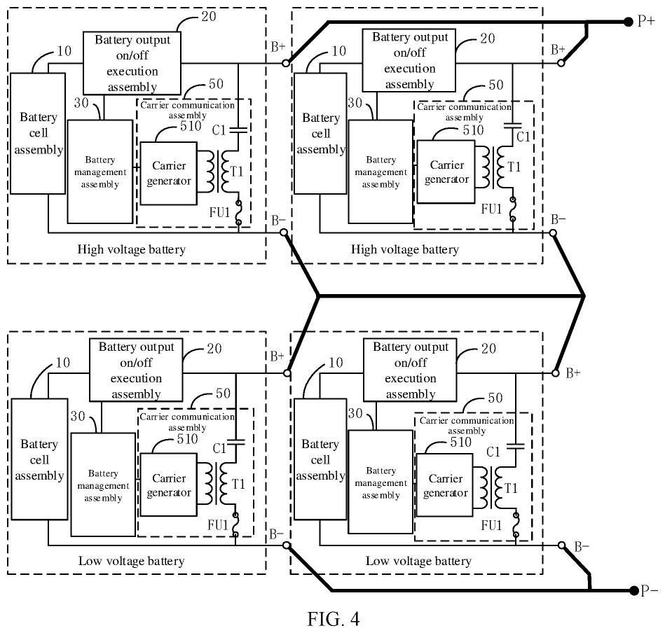

In the embodiment, referring to FIG. 4, the carrier communication assembly 50 includes a carrier generator 510, a coupling transformer T1, a blocking capacitor C1 and a fuse FU1.

The carrier generator 510 is respectively connected to the battery management assembly 30 and the coupling transformer T1.

The coupling transformer T1 is respectively connected to a second end of the blocking capacitor C1 and a first end of the fuse FU1, a first end of the blocking capacitor is connected to a positive electrode of the battery, and a second end of the fuse FU1 is connected to a negative electrode of the battery.

The carrier generator 510 is configured to demodulate a carrier signal into a digital signal and output the digital signal to the battery management assembly 30 in response to receiving the carrier signal, and modulate the digital signal into the carrier signal and output the carrier signal to the coupling transformer T1 in response to detecting the digital signal sent by the battery management assembly.

The coupling transformer T1 is configured to couple the carrier signal.

The blocking capacitor C1 is configured to isolate a direct-current voltage of the batteries.

The fuse FU1 is configured to protect the battery cell assembly from a short circuit caused by isolation failure of the blocking capacitor.

It can be understood that, in a series-parallel battery system constructed by lithium batteries that support series-parallel connection, when a plurality of batteries with different voltages and capacities in the system have failures such as over-temperature, over-voltage, over-current, under-voltage, or low battery, a failure of a single battery will implicate and damage other batteries, and even cause damage to the entire series-parallel battery system, since other batteries do not have a bridge to communicate with each other. Therefore, to establish a reliable series-parallel battery system, this embodiment includes a carrier communication assembly 50 for enabling communication between a plurality of lithium batteries supporting series-parallel. This communication allows for the disconnection of the entire series-parallel battery system when severe battery failures occur, thereby maintaining a safe and reliable working state for lithium batteries that support series-parallel connection.

In addition, each battery management assembly 30 monitors the working status of the system carrier communication through the carrier communication component 50. If a plurality of battery management assemblies 30 establish communication connections and transmit carrier signals to each other at the same time, errors in the transmitted carrier signals may easily occur. In order to prevent the simultaneous transmission of carrier signals between a plurality of battery management assemblies 30 from affecting the accuracy of the carrier signals, the carrier generator 510 will first detect whether there is a carrier signal in the system before each battery management assembly 30 connected to the battery cell assembly 10 needs to send a data packet to other battery management assemblies 30. When the carrier generator 510 detects the carrier signal, it will first delay using a random length of time, and then detect the carrier signal; after confirming that there is no carrier signal, the data packet will be processed and output to other battery management assemblies 30. Moreover, the delay time of each carrier generator 510 is not the same, thereby preventing a plurality of battery management assemblies 30 from transmitting carrier signals to each other at the same time when a plurality of carrier generators 510 output carrier signals at the same time, causing errors in the carrier signals.

For example, in an embodiment, referring to FIG. 4, a description is given as an example in which two high-voltage batteries are connected in parallel, two low-voltage batteries are connected in parallel, and two high-voltage batteries and two low-voltage batteries are connected in series.

Specifically, in response that the series-parallel battery system is in the working state, the battery management assembly 30 in the high-voltage battery is started, the carrier generator 510 detects the carrier signal and delays it randomly, and then detects the carrier signal; after confirming that there is no carrier signal, the carrier signal to be sent is output to the coupling transformer T1, and then the coupling transformer T1 couples the carrier signal and outputs it to the blocking capacitor C1. The blocking capacitor C1 isolates the coupled carrier signal from the direct current (DC) voltage and outputs the high-frequency carrier signal to other batteries, thereby establishing communication between the batteries.

Besides, the blocking capacitor C1 in this embodiment is configured to isolate DC, so that the carrier signal output by the coupling transformer T1 only allows a high-frequency carrier signal to pass, thereby achieving isolation. However, when the blocking capacitor C1 is broken down, the battery cell assembly 10 is prone to short circuit; therefore, this embodiment is also provided with a fuse FU1 to perform a fusing action immediately when the blocking capacitor C1 is broken down, so as to disconnect the path between the battery cell assembly and the blocking capacitor C1, thereby preventing the battery cell assembly 10 from being short-circuited.

In this embodiment, referring to FIG. 5, the wake-up detection assembly 40 includes a parallel wake-up detection assembly 410 and a discharge wake-up detection assembly 420.

The parallel wake-up detection assembly 410 is configured to wake up high-voltage batteries.

The discharge wake-up detection assembly 420 is configured to wake up low-voltage batteries.

It should be understood that batteries with low voltage properties have charge-discharge control detection assemblies 60 inside, but they are usually not needed. In this embodiment, the charge-discharge control detection assembly 60 inside the high-voltage battery is configured to control the battery system to start working.

In an embodiment, referring to FIG. 5, a description is given as an example in which two high-voltage batteries are connected in parallel, two low-voltage batteries are connected in parallel, and two high-voltage batteries and two low-voltage batteries are connected in series.

Specifically, when the charge-discharge control detection assembly 60 detects that the discharge switch and an auxiliary power supply of a charger are turned on, the high-voltage battery is started and the battery system is in the working state. The battery management assembly in the high-voltage battery controls the relay K1 to conduct and the MOS resistor Q1 to turn on, that is, conduct the current-limiting path between the high-voltage battery and other batteries. The battery voltage output by the battery cell assembly 10 in the high-voltage battery passes through the relay K1, MOS transistor Q1, current-limiting resistor R1 and current-limiting resistor R2 in sequence, and is output to the parallel wake-up detection assembly 410 in the next high-voltage battery. After the parallel wake-up detection assembly 410 detects the battery voltage, it wakes up the battery management assembly 30 in the high-voltage battery to start the high-voltage battery.

In an embodiment, the battery management assembly 30 in the high-voltage battery turns on the relay K2 and the MOS transistor Q2 after it is awakened by the paralleled wake-up detection assemblies 50. That is, to conduct the current-limiting path between the high-voltage battery and the low-voltage battery. The voltage output by the positive electrode of the battery cell assembly 10 in the high-voltage battery passes through the relay K2, MOS resistor Q2, and current-limiting resistor R2 in sequence, and is loaded to the external load Cload. The load current passes through the cell of the low-voltage battery, relay K3, MOS transistor Q3, current-limiting resistor R3, relay K4, MOS transistor Q4 and current-limiting resistor R4, and flows back to the negative electrode of the battery cell assembly 10. The discharge current flowing through R3 and R4 causes the discharge wake-up assembly 420 in the low-voltage battery to output a discharge wake-up detection signal to wake up the battery management assembly 30 in the low-voltage battery, thereby starting the low-voltage battery.

In an embodiment, all paths between high-voltage batteries and low-voltage batteries connected in series and parallel are opened, the battery system enters the official working state.

In the embodiment, the lithium battery supporting series-parallel further includes: a function button and a display assembly.

The function button is connected to the battery management assembly, and the function button is configured to trigger the battery management assembly to control a display assembly to work.

The display assembly is connected to the battery management assembly, and the battery management assembly is also configured to control the display assembly to work in response to being triggered.

It is understood that compared with a single battery, a series-parallel battery system supports multiple batteries with different voltages and capacities, and can provide corresponding voltages and capacities for different electrical equipment. If the performance of a battery in a series-parallel battery system deteriorates, the user only needs to replace the degraded battery, and the power supply to the electrical equipment will not be affected. However, when the series-parallel battery system is working, the user cannot know the remaining power capacity of the battery and the level of battery degradation.

Therefore, this embodiment is also provided with the function button and the display assembly. The display assembly is configured to display battery power capacity information and battery alarm information. The function button is configured to trigger the battery management assembly 30 to control the display assembly to display corresponding information. Function buttons include power function button and alarm function button; the power function button is configured to trigger the battery management assembly 30 to control the display assembly to display the battery power capacity information, and the alarm function button is configured to trigger the battery management assembly 30 to control the display assembly to display the battery alarm information.

In an embodiment, the display assembly can be implemented by using a light-emitting diode (LED) display screen and a liquid crystal screen.

In an embodiment, the function buttons can be implemented as a power function button and an alarm function button.

In an embodiment, a description is given as an example in which the display assembly is the LED display screen and the function buttons are the power function button and the alarm function button. The LED display screen, power function button and alarm function button are electrically connected to the battery management assembly 30 respectively.

Specifically, in practical applications, user presses the power function button, and the battery management assembly 30 controls the LED display screen to display the battery power capacity information, so that the user can monitor the power capacity of the current battery based on the battery power capacity information. Further, when the user presses the alarm function button, the battery management assembly 30 controls the LED display screen to switch to display battery alarm information, so that the user can monitor the current level of battery deterioration based on the battery alarm information. Therefore, the function button provided in this embodiment provides the user with the function of switching information by the display assembly, so that the user can monitor the battery power information and the deterioration level of the battery.

The above are only some embodiments of the present application, and do not limit the scope of the present application. Under the concept of the present application, any equivalent structural transformations made by using the description and accompanying drawings of the present application, or direct/indirect application in other related technical fields, are included in the scope of the present application.

What is claimed is:

1. A lithium battery supporting series-parallel, comprising:
a battery cell assembly, configured to store electric energy;
a carrier communication assembly, configured to establish communication among a plurality of lithium batteries supporting series-parallel;
a wake-up detection assembly, configured to provide a wake-up signal for batteries which do not use a charge-discharge control detection assembly in a series-parallel battery system, so as to switch the batteries from a shutdown state to a working state;
the charge-discharge control detection assembly, configured to detect on/off status of a discharge switch and an auxiliary power supply of a charger, so as to provide a booting signal and a shutdown signal for a battery management assembly;
the battery management assembly, configured to manage wake-up, startup, charging-discharging and communication of the batteries in response to receiving the booting signal, and manage shutdown of the batteries in response to receiving the shutdown signal; and
a battery output on/off execution assembly, configured to control on and off of a battery charge-discharge circuit and a current limiting charge-discharge circuit, receive control of the battery management assembly, provide feedback to the battery management assembly, and provide the wake-up signal for the wake-up detection assembly,
wherein the battery management assembly is electrically connected to the battery cell assembly, the carrier communication assembly, the wake-up detection assembly, the charge-discharge control detection assembly, the battery management assembly and the battery output on/off execution assembly respectively.

2. The lithium battery supporting series-parallel of claim 1, wherein:
the battery output on/off execution assembly comprises a contactor, a relay, a metal-oxide-semiconductor (MOS) transistor and a current-limiting resistor; and
a first end of the contactor is connected to the battery cell assembly, and a second end of the contactor is connected to a second end of the current limiting resistor; and a connecting point between the first end of the contactor and the battery cell assembly is connected to a first end of the relay, a first end of the current limiting resistor is connected to a second end of the MOS transistor, and a first end of the MOS transistor is connected to a second end of the relay.

3. The lithium battery supporting series-parallel of claim 2, wherein in response to constructing a battery system, a plurality of the batteries are connected in series-parallel, the batteries with highest voltage in the battery system are high-voltage batteries, and the batteries except the high-voltage batteries are low-voltage batteries.

4. The lithium battery supporting series-parallel of claim 3, wherein:
the battery management assembly in the low-voltage batteries is configured to control the contactor to disconnect, the relay to conduct and the MOS transistor to turn on during system shutdown and wake-up processes, so as to conduct current-limiting paths between the low-voltage batteries and other batteries, and control the contactor to connect, the relay to disconnect and the MOS transistor to turn off after the system is started up.

5. The lithium battery supporting series-parallel of claim 3, wherein:
the charge-discharge control detection assembly is configured to output the booting signal after detecting the turn on of a discharge switch or the auxiliary power supply of the charger, and output the shutdown signal after detecting the turn off of the discharge switch or the auxiliary power supply of the charger; and
the battery management assembly in the high-voltage batteries is configured to control the relay to conduct and the MOS transistor to turn on in response to receiving the booting signal, so as to conduct current-limiting paths between the high-voltage batteries and other batteries, and control the contactor and the relay to disconnect and the MOS transistor to turn off in response to receiving the shutdown signal, so as to completely disconnect charging-discharging paths between the series-parallel battery system and an external load.

6. The lithium battery supporting series-parallel of claim 1, wherein:
the carrier communication assembly comprises a carrier generator, a coupling transformer, a blocking capacitor and a fuse;
the carrier generator is respectively connected to the battery management assembly and the coupling transformer;
the coupling transformer is respectively connected to a second end of the blocking capacitor and a first end of the fuse, a first end of the blocking capacitor is connected to a positive electrode of the battery, and a second end of the fuse is connected to a negative electrode of the battery;
the carrier generator is configured to demodulate a carrier signal into a digital signal and output the digital signal to the battery management assembly in response to receiving the carrier signal, and modulate the digital signal into the carrier signal and output the carrier signal to the coupling transformer in response to detecting the digital signal sent by the battery management assembly;
the coupling transformer is configured to couple the carrier signal;
the blocking capacitor is configured to isolate a direct-current voltage of the batteries; and
the fuse is configured to protect the battery cell assembly from a short circuit caused by isolation failure of the blocking capacitor.

7. The lithium battery supporting series-parallel of claim 1, wherein the wake-up detection assembly comprises:
a parallel wake-up detection assembly, configured to wake up high-voltage batteries; and
a discharge wake-up detection assembly, configured to wake up low-voltage batteries.

8. The lithium battery supporting series-parallel of claim 1, further comprising:
a function button connected to the battery management assembly,
wherein the function button is configured to trigger the battery management assembly to control a display assembly to work.

9. The lithium battery supporting series-parallel of claim 1, further comprising:
a display assembly connected to the battery management assembly,
wherein the battery management assembly is also configured to control the display assembly to work in response to being triggered.
